(19) United States
(12) Patent Application Publication
(10) Pub. No.: US 2025/0170526 A1
(43) Pub. Date: May 29, 2025

(54) PROCESS FOR SEPARATING WASTE GAS FROM A FERROUS METAL PRODUCTION UNIT

(71) Applicant: L'Air Liquide, Societe Anonyme pour l'Etude et l’Exploitation des Procedes Georges Claude, Paris (FR)

(72) Inventors: Pascal MARTY, Paris (FR); Guillaume RODRIGUES, Paris (FR); Laurette MADELAINE, Paris (FR)

(21) Appl. No.: 18/955,914

(22) Filed: Nov. 21, 2024

(30) Foreign Application Priority Data
Nov. 24, 2023 (FR) FR 2313009

(51) Int. Cl. B01D 53/62; B01D 53/04; B01D 53/047; B01D 53/73

(52) U.S. Cl. CPC B01D 53/62; B01D 53/0462; B01D 53/047; B01D 53/73; B01D 2257/102; B01D 2257/108; B01D 2257/502; B01D 2257/504; B01D 2258/025

(57) ABSTRACT

A process for separating waste gas from a ferrous metal production unit uses a first adsorption unit to separate the waste gas by pressure swing adsorption to produce a gas depleted in carbon monoxide and hydrogen and enriched in CO₂ relative to the waste gas, and a first gas enriched in carbon monoxide and hydrogen and depleted in CO₂ relative to the waste gas, a unit for separation by partial condensation and/or distillation, a second adsorption unit, and a second gas enriched in CO and hydrogen relative to the first CO-enriched gas, the second gas containing nitrogen, a unit for separation by partial condensation and/or washing and/or distillation, means for sending at least a portion of the CO and hydrogen enriched second gas to the separation unit for separation therein to produce a gas depleted in nitrogen and enriched in CO relative to the second gas.

### CROSS-REFERENCE TO RELATED APPLICATIONS

This application claims the benefit of priority under 35 U.S.C. § 119 (a) and (b) to French patent application No. FR 2313009, filed Nov. 24, 2023, the entire contents of which are incorporated herein by reference.

### BACKGROUND

### Field of the Invention

The present invention relates to a process for separating waste gas from a ferrous metal production unit.

### Related Art

A process for producing cast iron in a smelting reactor such as a blast furnace is a process in which at least iron ore, an oxidizer and a fuel are introduced into the furnace so as to melt the ore and obtain cast iron containing at most 5% carbon, in which gases (referred to as “blast furnace gases”) are recovered at the reactor outlet, containing, on a dry basis, from 15 to 45 mol % of CO₂, from 15 to 45 mol % of CO, the balance consisting essentially of nitrogen, hydrogen, various hydrocarbons and a small percentage of argon, and the CO₂ is then separated from the rest of the blast furnace gas, the latter being sent to means for using said gas. Preferably, the blast furnace gases comprise from 15 to 30 mol % of CO and/or CO₂, each on a dry basis. The blast furnace is an iron- and steel-making tool which produces cast iron from a feed of iron ore and coke, the oxidizer of the combustion being air optionally enriched with oxygen. The iron ore is heated, reduced and melted by the coke, whose combustion with air provides some of the energy needed to heat and melt the iron ore. It is of course possible, in addition to coke, to use coal or another hydrocarbon injected into the tuyeres of the blast furnace. On the other hand, carbon monoxide is produced, resulting from the combustion reaction of coke and/or coal and/or hydrocarbon with the air known as blast which is injected into said tuyeres, enriched or not with oxygen. This carbon monoxide is necessary for the reduction of iron ore. The annual production of cast iron in a blast furnace can reach a hundred thousand tonnes for the smallest of them and several million tonnes for the most productive. In the same plant, it is possible to have one or more blast furnaces, possibly up to ten on certain sites. As a result of the combustion and the reactions generated in the blast furnace, a “blast furnace gas” is recovered at the outlet of the furnace, and is a mixture typically of nitrogen (between about 35 and 65 percent by volume), which comes essentially from the air injected into the blast furnace tuyeres, carbon monoxide (between about 15 and 30 mol %) and carbon dioxide (also between about 15 and 30 mol %), resulting from the partial or total combustion of the coke or in general the fuel injected. This combustion is also the cause of water vapour being present, since the general reaction between a carbon-containing product and oxygen during combustion essentially produces CO₂ and H₂O. Other gases are also found in the blast furnace gas, in an overall lesser quantity, generally less than the overall quantity of 12 percent by volume, these other gases consisting in particular of hydrogen, various hydrocarbons, argon from the air, etc. This blast furnace gas is a “lean” gas since it has a low calorific value, typically of between 2000 and 6000 KJ/Nm³, as opposed to other iron- and steel-making gases referred to as “rich” because they have a much higher calorific value (for example, gases from a cast iron-to-steel converter or a coke oven, having calorific values typically of between 6000 and 10 000 KJ/Nm³ and between 12 000 and 20 000 KJ/Nm³, respectively). In general, the quantity of gas produced by a blast furnace is very large and of the order of about 1500 Nm³ of gas per tonne of cast iron produced. The result is that, given the composition of said gas, the quantity of carbon dioxide produced per tonne of cast iron is also very large: for example, for a blast furnace gas with an average carbon dioxide content of 22 percent in the dry gas and for a blast furnace producing one million tonnes of cast iron per year, the quantity of carbon dioxide emitted in the blast furnace gases is 330 million Nm³ per year, i.e. about 650 000 tons of carbon dioxide produced in one year. For a blast furnace that produces 3 million tonnes of cast iron per year, the quantity of CO₂ emitted is about 2 million tonnes per year, while for a site that produces 7 million tonnes of cast iron per year, the quantity of CO₂ is about 4.5 million tonnes. These quantities are quite considerable and, given the negative effect of these gases with respect to the atmosphere and the environment, it is not possible to contemplate sending them directly into the atmosphere in this way. Furthermore, discharging said gases into the atmosphere would also entail sending carbon monoxide into the atmosphere, which is known to be very dangerous, and it is therefore necessary to provide systems for recovering this blast furnace gas.

The typical composition of an example of a waste gas from a ferrous metal production unit, here a blast furnace gas or “top gas”, is as follows:
H₂: 4-5 mol %.
CO: 24-25%.
CO₂: 23-25%
N₂: 40-45%
H₂O: 3%

The aim of the extractions of the CO₂ and of the N₂ present in the top gases from blast furnaces is to upgrade them:
as fuel (higher calorific value) to turbines (electricity generation for an integrated steel mill) or to other users of the steel mill (such as cowpers, mixed with other fuel gases (coke oven gas or natural gas) to preheat the enriched air)
as reducing gas for the coal in the blast furnace itself,

It is also known practice from EP3997235A1 to use blast furnace gas containing more than 20 mol % of CO as a starting material for the production of biofuels to convert the CO into at least one biofuel, for example bioethanol.

Bioreactors operating, for example, according to WO 08/115080, in which CO is converted into bioethanol, may be used.

### SUMMARY OF THE INVENTION

One object of the present invention is to produce a CO-rich flow from a ferrous metal production unit, at the same time as capturing CO₂ produced by the production unit.

According to one subject of the invention, a process is provided for separating waste gas from a ferrous metal production unit, in which:
i) the waste gas contains at least CO, CO₂, hydrogen and nitrogen, and is compressed in a first compressor and then separated by pressure swing adsorption in a first adsorption unit to produce a gas depleted in carbon monoxide and hydrogen and enriched in CO₂ relative to the waste gas and a first gas enriched in carbon monoxide and hydrogen and depleted in CO₂ relative to the waste gas, containing not more than 2 mol % of CO₂
ii) the CO₂-enriched gas is sent to a unit for separation by partial condensation and/or distillation and/or solidification which produces a CO₂-rich fluid containing at least 80 mol % of CO₂, or even at least 95 mol % of CO₂
iii) at least part of the CO-enriched gas is separated by temperature swing adsorption in a second adsorption unit to form a gas enriched in CO₂ relative to the first CO-enriched gas at a first pressure and a second gas enriched in CO and hydrogen relative to the first CO-enriched gas, the second gas containing nitrogen, and
iv) at least part of the CO- and hydrogen-enriched second gas is compressed and separated by partial condensation and/or washing and/or distillation to produce a third fluid enriched in nitrogen and depleted in hydrogen and CO relative to the second gas, and a fourth gas depleted in nitrogen and enriched in CO and/or hydrogen relative to the second gas.

According to other optional aspects:
at least a portion of the second and/or fourth CO-enriched gas is sent to a process for producing biofuel, for example ethanol, by fermentation.
at least a portion of the CO- and hydrogen-enriched second and/or fourth gas is compressed and separated by partial condensation and/or washing and/or distillation to produce a third fluid enriched in nitrogen and depleted in hydrogen and CO relative to the second gas, and a fourth gas depleted in nitrogen and enriched in CO and/or hydrogen relative to the second gas.
at least a portion of the second gas is separated by partial condensation and/or washing and/or distillation to produce the fourth gas enriched in CO and depleted in hydrogen and nitrogen relative to the second gas and a fifth gas depleted in nitrogen and CO and enriched in hydrogen relative to the second gas
at least a portion of the fourth gas and/or the fifth gas is sent to a process for producing biofuel, for example ethanol, by fermentation.
at least a portion of the third fluid is sent to the process for producing biofuel, for example ethanol, by fermentation.
the CO₂-enriched gas produced by temperature swing adsorption is mixed with the CO₂-enriched gas, optionally upstream of a CO₂-enriched gas compression step.
the waste gas contains between 15 and 45 mol % of CO, preferably more than 20 mol % of CO.
the first CO-enriched gas is enriched in nitrogen relative to the waste gas.
the second CO-enriched gas contains at least 60 mol % of CO.
at least a portion of the gas containing at least 60 mol % of CO is separated at cryogenic temperature by partial condensation and/or washing and/or distillation to reduce its nitrogen content, forming a gas containing at least 80 mol % of CO and also hydrogen and a nitrogen-enriched gas.
the waste gas contains argon and cryogenic separation produces an argon-enriched fluid,
cryogenic separation produces a hydrogen-enriched fluid,
the CO₂-depleted and CO-enriched gas contains at least 85%, preferably at least 90%, of the CO present in the gas mixture sent to the first adsorption unit.
the CO₂-depleted and CO-enriched gas contains not more than 83%, preferably not more than 80%, of the CO present in the gas mixture sent to the first adsorption unit,
the gas depleted in carbon monoxide and hydrogen and enriched in CO₂ relative to the waste gas contains at least 70%, preferably at least 80%, or even at least 90% or at least 95% of the CO₂ present in the gas mixture sent to the first adsorption unit,
a regeneration gas sent to the second adsorption unit is formed from a portion of the gas containing at least 60% mol of CO.
a regeneration gas sent to the second adsorption unit is formed from a gas produced by cryogenic separation,
the CO₂-enriched gas is separated in a separation unit by partial condensation and/or distillation and/or solidification, forming at least one gas richer in CO and hydrogen than the CO₂-enriched gas, and this at least one gas richer in CO and hydrogen is sent to be separated in the first adsorption unit,
the CO₂-enriched gas contains water and is dried in a drying unit upstream of the separation unit by partial condensation and/or distillation and/or solidification, a regeneration gas containing CO and/or hydrogen is used to regenerate the drying unit and is then sent to be separated in the first adsorption unit,
a portion of the second gas is separated at cryogenic temperature by partial condensation and/or washing and/or distillation to reduce its nitrogen content, forming a gas containing at least 80 mol % of CO and also hydrogen and a nitrogen-enriched gas,
the waste gas contains argon and separation by partial condensation and/or washing and/or distillation produces an argon-enriched fluid,
cryogenic separation produces a fluid containing at least 80% hydrogen,
at least a portion of the gas enriched in CO₂ relative to the first CO-enriched gas and produced by the second adsorption unit is sent upstream of the first adsorption unit for separation,
at least a portion of the gas enriched in CO₂ relative to the first CO-enriched gas and produced by the second adsorption unit is sent upstream of the separation unit by partial condensation and/or distillation and/or solidification for separation,
at least a portion of the gas enriched in CO₂ relative to the first CO-enriched gas and produced by the second adsorption unit is sent to the ferrous metal production unit, for example a blast furnace.

Surprisingly, the best optimization of the process is that in which a pressure swing adsorption unit purifies a gas from the metal production unit containing at least 20% carbon monoxide and operates with the aim of maximizing the CO₂ yield of the CO₂-enriched gas produced by this adsorption.

### BRIEF DESCRIPTION OF THE FIGURES

The invention will be described in more detail with reference to the figures, in which:

FIG. 1 represents a comparative process.

FIG. 2 represents a comparative process.

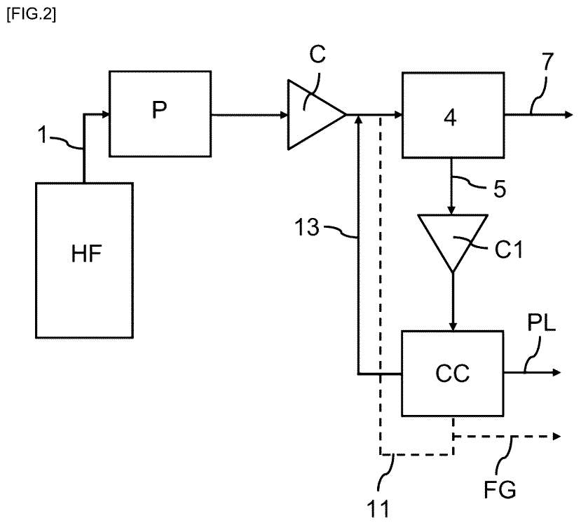

FIG. 3 represents a process according to the invention.

### DETAILED DESCRIPTION OF THE INVENTION

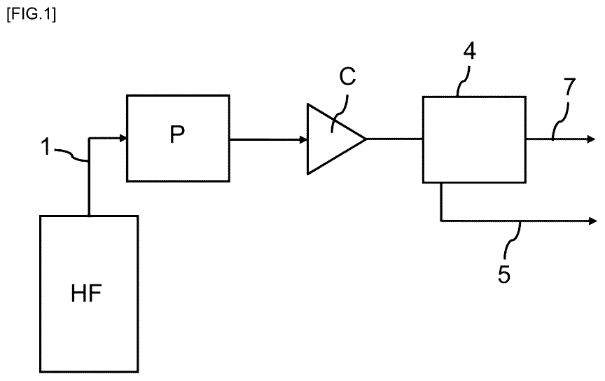

FIG. 1 illustrates a process for separating a top gas produced by a blast furnace HF which is purified in a pretreatment unit P to remove the dusts it contains, compressed by a compressor C1 and separated by pressure swing adsorption in a separation unit 4, to produce a gas enriched in CO and nitrogen and depleted in CO₂ 7 relative to the gas 1 to be separated and a gas depleted in CO and nitrogen and enriched in CO₂ 5 relative to the gas to be separated.

In the case of a unit 4 for separation by pressure swing adsorption, known as PSA, which processes a waste gas from a ferrous metal unit compressed to approximately 8 bar and is operated in “high CO yield” mode, the yield for recovery of CO at high pressure in the gas 7 is typically greater than 80% (or even greater than 85%) for corresponding yields of low-pressure CO₂ extraction in the gas 5 at around 88% and N₂ yields of 15%. It is sought both to maximize the yield for recovery of CO and the yields for extraction of CO₂/N₂.

The CO-rich stream 7 generated by the PSA 4 thus also contains a lot of nitrogen (about 85 mol % of the flow of gas treated) because the CO/N₂ selectivity is very low on conventional adsorbents. It also contains hydrogen and CO₂ (about 12% of the flow of gas treated).

The CO₂-rich gas produced at low pressure by the PSA also contains non-adsorbed CO (about 15% of the flow of top gas treated), H₂, nitrogen and the water present in the top gas.

TABLE 1
represents an example of a material balance obtained for a PSA 4
operating in “high CO yield” mode on waste gas 1 at about 8 bar
as illustrated in [FIG. 1]:

| | PSA inlet 4 | CO-enriched gas 7 | CO₂-enriched gas 5 |
|---|---|---|---|
| Flow rate | 100 | 67 | 33 |
| H₂ mol % | 5 | 8 | 1 |
| CO | 25 | 32 | 11 |
| CO₂ | 26 | 5 | 68 |
| N2 | 43 | 55 | 18 |
| H₂O | 1 | 0 | 2 |

CO recovery yield = 85.8%

It is known practice from EP1869385 to separate the CO₂-enriched gas produced at low pressure by adsorptive separation of a top gas from a ferrous metal unit, for example by partial condensation and/or distillation. These two technologies can be integrated by recycling all or part of the stream of gas depleted in CO₂ and containing CO originating from the separation by partial condensation and/or distillation in a separation unit CC upstream or downstream of the compressor of the gas C feeding the PSA 4, saving 10% or more of the compression energy of the PSA 4.

[TAB.2] shows the example of a material balance obtained for a PSA 4 operating in “high CO yield” mode on the waste gas 1 from a blast furnace HF at about 8 bar combined with a unit CC for separation by partial condensation and/or distillation and/or solidification:

TABLE 2

| | PSA inlet 4 | CO-enriched gas 7 | CO₂-enriched gas 5 |
|---|---|---|---|
| Flow rate | 100 | 80 | 20 |
| H₂ mol % | 5 | 7 | 0 |
| CO | 25 | 31 | 0.5 |
| CO₂ | 26 | 7 | 99 |
| N2 | 43 | 55 | 0.5 |
| H₂O | 1 | 0 | 0 |

In this case, the CO recovery yield is close to 100%. Recycling gases 11 and/or 13 to the PSA helps to push it closer to 100%.

It is possible to operate the PSA on the top gas 1 in “high CO₂ yield” mode with a degraded yield for CO recovery, which enables an increase in the yield for CO₂ extraction. This functioning can be obtained by modifying the cycle of the PSA and/or by altering the quality of the adsorbents and/or by allowing less CO₂ to enter the CO-rich gas.

Example of yields that may be obtained by a PSA 4 on top gas at 8 bar:

TABLE 3

| | | | High CO₂ |
|---|---|---|---|
| PSA 4 | | High CO yield | production in |
| MODE | | in gas 7 | gas 5 |
| Yield of CO | % | 85 | 80 |
| in gas 7 | | | |
| N₂ yield | % | 86 | 82 |
| in gas 7 | | | |
| CO₂ yield | % | 13 | 2 |
| in gas 7 | | | |
| H₂ yield | % | 94 | 93 |
| in gas 7 | | | |

In “High CO Yield” operating mode, PSA 4 is operated to maximize the percentage of CO recovered from gas 7 sent to the TSA unit. Thus, it is seen that 85% of the CO present in the gas at the PSA 4 inlet is subsequently found in gas 7, along with 94% of the hydrogen. However, a significant percentage of the CO₂ (13%) is found in gas 7.

Operating in “high CO₂ production” mode may result in a CO-rich flow HP 7 containing not more than 2 mol % of CO₂. On the other hand, a reduction in the partial flow of CO produced (i.e. the CO recovery yield) will be observed. Surprisingly, in order to optimize the entire process to produce the flow containing sufficiently little CO₂ to allow the TSA unit to remove all the remaining CO₂, it is necessary to regulate the operation of PSA 4 to reduce the CO₂ content as much as possible in the CO-enriched gas 7 produced.

On a blast furnace “top gas”, if it is desired simultaneously to obtain:
a maximum degree of CO recovery
and/or a maximum degree of recovery of a purified CO₂-rich stream produced in liquid or gaseous form
and/or a CO-rich stream more or less depleted in N₂

The invention proposed below may be implemented. It consists in combining the PSA preferably operating in “High CO₂ Production” mode with:
a CO₂ separation unit by partial condensation and/or distillation and/or solidification (and its appropriate recycles) to produce purified CO₂ in liquid or gaseous form, and
a CO₂ TSA on the CO-rich stream produced by the PSA to adsorb residual CO₂ (not more than 2%). The regeneration gas required must not contain any CO₂ and may come from:
TSA CO₂ product (see note below)
The N₂ stream or CO stream produced by the downstream cold box
An external stream

The waste gas thus generated may (or may not) be recycled into the PSA inlet and/or the CO₂ separation unit inlet by partial condensation and/or distillation and/or solidification, or into the blast furnace, always with the aim of improving the H₂/CO and CO₂ molecule recovery yields.
A cryogenic unit (cold box with partial condensation and/or washing (for example washing with liquid N₂ or liquid CO) and/or distillation steps with or without associated refrigeration cycle) in series with the TSA on the CO-rich stream for partial or total separation of the nitrogen present in the CO-rich stream. A third waste gas optionally created in the cryogenic unit may also be recycled upstream of the PSA or upstream of the CO₂ separation unit by partial condensation and/or distillation and/or solidification.

The cryogenic unit may be preceded by a CO-rich gas compression step.

The cryogenic unit may be used to produce at least one auxiliary stream that is more or less rich in H₂ and/or at least one auxiliary stream rich in argon (argon coming from the air and O₂ introduced into the blast furnace and ending up in the top gas).

The relatively high CO₂ content that the TSA will have to remove upstream of the N₂/CO cold box will require a significant amount of heat. Using a portion of the decarbonated gas available downstream of this TSA is not necessarily desirable for two reasons. On the one hand, it would lead to a loss in CO/H₂ yield if this regeneration gas is sent to the fuel network, or a loss in energy efficacy if this gas is recycled upstream of the PSA. On the other hand, the presence of CO/H₂ would limit the regeneration temperature to 150° C., so as to dispense with reactivity problems at the TSA regeneration gas heater. It would then be preferable to use the N₂ stream from the CO/N₂ cold box to regenerate the TSA and return the regeneration stream to the fuel network.

The main advantage of operating the PSA in “High CO₂ extraction” mode is to facilitate complete downstream CO₂ removal, which is notably compatible with TSA-type technology, and to open up the possibility of a final N₂/CO separation. The CO lost in the PSA waste gas will be recovered by the separation unit by partial condensation and/or distillation and/or solidification and recycled into the PSA inlet to improve the production yield.

The major drawback of this solution is an increase in the recycled gas flow and consequently in the equipment, and also an increase in the specific energy of the separation unit by partial condensation and/or distillation and/or solidification due to the depletion of CO₂ in the PSA waste gas.

Overall, therefore, pure CO₂ and a very CO-rich stream may be produced with high recovery yields. The amount of residual nitrogen in the CO-rich stream (i.e. the nitrogen extraction yield) may be suitable for use in the cold box. The purified CO thus produced may be directed either towards biofuel production units or recycled into the blast furnace (reduction of the CO₂ emitted by the blast furnace).

The PSA can be either dimensioned according to a “Maximum CO yield” mode (with choice of adsorbent and optimum cycle), or dimensioned according to a “High CO₂ extraction” mode (with choice of optimum adsorbent and/or cycle), or dimensioned so as to be able to be operated in both modes (requiring a suitable adsorbent+modification of the cycle during operation).

The coupling of a PSA CO₂ with separation by partial condensation and/or distillation and/or solidification has the following objectives:
both to enrich the PSA waste gas with CO₂ in order to minimize the specific energy of the separation process by partial condensation and/or distillation and/or solidification
and to increase the CO purity of the product that can be sent to a carbon monoxide-consuming process, such as a CO-to-ethanol conversion process that uses CO.

Example of a material balance obtained for a PSA4 operating in “High CO₂ yield” mode on top gas at about 8 bar combined with a low-temperature CO₂ separation unit CC, a TSA 6 and a CB cryogenic separation of CO and N₂:

TABLE 3

| | | CO produced | CO₂ produced | |
|---|---|---|---|---|
| | PSA inlet 4 | 17 | 14 | N₂ produced 19 |
| Flow | 100 | 31 | 26 | 43 |
| H₂ mol % | 5 | 17.5 | 0 | 0 |
| CO | 25 | 80.5 | 0.5 | 0.5 |
| CO₂ | 26 | 0 | 99 | 0 |
| N₂ | 43 | 2 | 0.5 | 99.5 |
| H₂O | 1 | 0 | 0 | 0 |

CO yield: close to 100%

Maximization of the CO yield of the PSA 4 can be sought so as to obtain a waste gas 5 from PSA 4 that is richer in CO₂, thus decreasing the specific energy of the separation by partial condensation and/or distillation and/or solidification CC. The main benefit of operating the PSA 4 in “high CO yield” mode is to increase the CO₂ concentration in the CO₂-enriched gas 5 from the PSA 4, the latter being the flow fed to the apparatus for separation by partial condensation and/or distillation and/or solidification CC. This scheme has the advantage of decreasing the OPEX, and to a lesser extent the CAPEX, of the apparatus for separation by partial condensation and/or distillation and/or solidification CC.

A typical material balance for PSA's CO₂-enriched gas CC system processing a blast furnace top gas is indicated below:

TABLE 4

| | | | Gaseous | Stripper | CO₂-rich |
|---|---|---|---|---|---|
| | CO₂-enriched | CO₂-rich | phase | top | liquid |
| | gas 5 | liquid | (#11) | (#22) | 14 |
| P bara | 1.05 | 65 | 35 | 21 | 21 |
| T° C. | 40 | −52 | −52 | −53 | −20 |
| Flow | 100 | 65 | 35 | 6 | 59 |
| H₂ mol % | 1 | 0 | 2.9 | 0.2 | 0 |
| CO | 11 | 2.2 | 29.9 | 24.6 | 0 |
| CO₂ | 68 | 94.1 | 21.2 | 33.9 | 100 |
| N₂ | 18 | 3.7 | 46 | 41.3 | 0 |
| H₂O | 2 | 0 0 | | 0 | 0 |
| N₂/CO | | | 1.53 | 1.7 | |
| ratio | | | | | |

The optimization of the compressor C1 (if present) for the CO₂-enriched gas 5 and of the external cold cycles make it possible to obtain specific energy consumptions of the order of 200 kW/ton of liquid CO₂ produced.

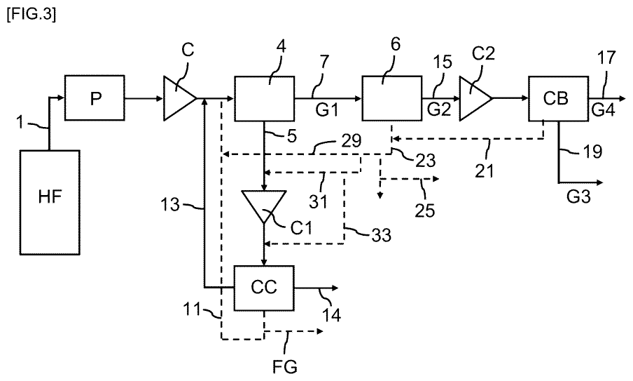

FIG. 3 illustrates a process according to the invention. It consists in combining a PSA 4 pressure swing adsorption separation unit, a partial condensation and/or distillation and/or solidification separation unit and a TSA 6 temperature swing adsorption separation unit. An example of a partial condensation and/or distillation separation unit is described in FR2310716 filed on Oct. 6, 2023.

A gas 1 including from 15 to 45 mol %, or even from 15 to 30 mol %, of CO₂, from 15 to 45 mol %, or even from 15 to 30 mol % of CO, the remainder consisting essentially of nitrogen, hydrogen, various hydrocarbons, water and a small percentage of argon. This gas is pretreated in a pretreatment unit P to remove solid impurities and is then compressed in a compressor C to a pressure of about 8 bar.

The compressed gas 1 is separated by pressure swing adsorption in unit 4, producing a gas enriched in CO and hydrogen 7 relative to the gas 1 entering unit 4, preferably containing not more than 2% of CO₂. Unit 4 also produces a gas 5 depleted in CO and enriched in CO₂ relative to gas 1 entering unit 4.

Gas 5 may be compressed in a compressor C1. Gas 5 is at a first pressure higher than the second pressure of gas 7.

Gas 5 is separated in the unit CC by partial condensation and/or distillation and/or solidification to form a CO₂-rich fluid (gas or liquid) 14 containing at least 80% mol of CO₂, or even at least 95% mol of CO₂. The unit CC also produces a gas 13 enriched in carbon monoxide and hydrogen relative to gas 5, which is sent upstream of PSA unit 4 or upstream of compressor C. Gas 13 may, for example, be a gas from a partial condensation step and/or an overhead gas from a distillation column. The unit CC produces a gas 11, enriched in carbon monoxide and hydrogen relative to gas 5, which is split in two, one part FG serving as fuel gas and another part 11 optionally being used to regenerate dryers (not illustrated) upstream of the unit CC. The regeneration gas 11 charged with water after regeneration is sent upstream of the PSA unit 4 or upstream of the compressor C. It is also possible to use part of the gas 15, 17, 21, 23, 31, 33 as regeneration gas.

Gas 7, G1 is separated by the adsorption unit 6 to form a gas 15 enriched in CO and H₂ relative to gas 7. Gas 15, G2 no longer contains CO₂, but still contains nitrogen.

As a variant, only unit 6 is used to separate gas 7, and gas 15 constitutes the product of the process.

The regeneration gas required to regenerate unit 6 must not contain CO₂ and may come from:
TSA CO₂ 6 product 15, 17, 19
An external stream

The waste gas 23 thus generated by the TSA 6 unit may (or may not) be recycled into the PSA 4 inlet (flow 29) and/or the unit CC inlet (flows 31, 33), or into the HF blast furnace, always with the aim of improving H₂/CO and CO₂ molecule recovery yields.

This gas 15 is optionally compressed in the compressor C2 and separated in a cryogenic CB unit. The CB unit comprises a thermally insulated chamber containing at least one phase separator and/or at least one washing column and/or at least one distillation column. The at least one washing column may be a liquid nitrogen or liquid carbon monoxide washing column. The CB unit may comprise at least one refrigeration cycle. The separation performed by the CB unit is a partial or total separation of the nitrogen present in the CO-rich stream 15. The CB unit produces a fluid 19 enriched in nitrogen and depleted in CO and hydrogen relative to gas 15. Fluid 19 may contain at least 90% mol of nitrogen. The CB unit produces at least one gas enriched in hydrogen and/or CO and depleted in nitrogen relative to gas 15. For example, it may produce at least one gas enriched in hydrogen and depleted in nitrogen and CO relative to gas 15 and/or at least one gas enriched in CO and depleted in nitrogen and hydrogen relative to gas 15.

The fermentation unit 13 is fed with at least a portion of gas 15 and/or at least a portion of at least one gas enriched in hydrogen and/or CO and depleted in nitrogen relative to gas 15 from the CB unit.

Preferably, it is fed with at least one gas enriched in hydrogen and depleted in nitrogen and CO relative to gas 15 and/or at least one gas enriched in CO and depleted in nitrogen and hydrogen relative to gas 15. Feeding the fermentation unit with two gases of different purity allows the CO and H₂ contents in the gas present in the fermentation unit to be varied. It is also possible to send a variable flow of nitrogen-enriched gas 19 to slow down the fermentation reaction.

Another possibility is to send at least a portion of the hydrogen-enriched gas depleted in nitrogen and CO relative to gas 15 and/or at least another portion of the CO-enriched gas depleted in nitrogen and hydrogen relative to gas 15 to another gas consumer.

Any waste gas 21 created in the cryogenic unit may also be recycled upstream of the PSA 4 (flow 29) or upstream of the unit CC (flow 31, 33).

The cryogenic CB unit may be used to produce at least one stream more or less rich in H₂, for example a fluid (gas or liquid) containing at least 80% mol of hydrogen and/or a fluid (gas or liquid) containing at least 80% mol of argon (the argon coming from the air and O₂ introduced into the blast furnace HF and ending up in the top gas 1).

The relatively high CO₂ content that the TSA 6 unit will have to remove upstream of the CB unit will require a significant amount of heat. Using a portion of the decarbonated gas 15 available downstream of this TSA 6 as regeneration gas is not necessarily desirable for two reasons. On the one hand, it would lead to a loss in CO/H₂ yield if this regeneration gas is sent to the fuel gas network, or a loss in energy efficacy if this gas is recycled upstream of the PSA 4. On the other hand, the presence of CO/H₂ would limit the regeneration temperature to 150° C., so as to avoid reactivity problems in the heater of the TSA 6 unit. It will then be preferable to use the N₂ stream 19 from the cold box CB to regenerate the TSA 6 and return the regeneration stream to the fuel network.

The main advantage of operating the PSA 4 unit in “High CO₂ Production” mode is to facilitate the complete downstream removal of CO₂, notably compatible with TSA-type technology, and to open up the possibility of a final N₂/CO separation. The CO lost in the PSA 4 waste gas 5 will be recovered by the separation unit CC by partial condensation and/or distillation and/or solidification and recycled into the PSA inlet to improve the production yield.

The major drawback of this solution is an increase in the recycled gas flow and consequently in the equipment, and also an increase in the specific energy of the unit CC due to the depletion in CO₂ of the waste gas 5 from the PSA 4 unit.

Overall, therefore, pure CO₂ and a very CO-rich stream may be produced with high recovery yields. The amount of residual nitrogen in the CO-rich stream (i.e. the nitrogen extraction yield) may be suitable for use in the cold box. The purified CO thus produced may be directed either towards units for the production of biofuel, for example ethanol (using a Lanzatech process for example), or recycled in the blast furnace (reduction of the CO₂ emitted by the blast furnace).

The PSA 4 may be either sized according to a “High CO yield” mode (choice of adsorbent and optimum cycle), or sized according to a “High CO₂ yield” mode (choice of adsorbent and optimum cycle), or sized so as to be able to operate according to both modes (suitable adsorbent+cycle modification during operation).

The regeneration gas required to regenerate unit 6 must not contain CO₂ and may come from:
TSA 6 CO₂ product
Nitrogen 19, G3 or CO 17, G4 produced by the downstream CB unit
An external stream

As a fermentation process producing a biofuel, for example ethanol, has variable requirements in terms of feed gas, it is possible to send therein a mixture of at least two gases produced via the process according to the invention, for example a portion of at least two of the gases 15, 17, 19, 21 and a hydrogen-enriched gas produced by the CB unit.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A process for separating waste gas from a ferrous metal production unit, comprising:
i) compressing the waste gas contains at least CO, CO₂, hydrogen and nitrogen in a first compressor, thereby producing a compressed waste gas stream, and then separating the compressed waste gas stream by pressure swing adsorption in a first adsorption unit thereby producing a gas depleted in carbon monoxide and hydrogen and enriched in CO₂ relative to the waste gas and a first gas enriched in carbon monoxide and hydrogen and depleted in CO₂ relative to the waste gas, the first gas containing not more than 2 mol % of CO₂,
ii) sending the CO₂-enriched gas to a unit for separation by partial condensation and/or distillation and/or solidification thereby producing a CO₂-rich fluid containing at least 80 mol % of CO₂,
iii) separating at least part of the CO-enriched gas by temperature swing adsorption in a second adsorption unit thereby forming a gas enriched in CO₂ relative to the first CO-enriched gas at a first pressure and a second gas enriched in CO and hydrogen relative to the first CO-enriched gas, the second gas containing nitrogen, and
iv) compressing at least part of the CO- and hydrogen-enriched second gas and separating by partial condensation and/or washing and/or distillation thereby producing a third fluid enriched in nitrogen and depleted in hydrogen and CO relative to the second gas, and a fourth gas depleted in nitrogen and enriched in CO and/or hydrogen relative to the second gas.

2. The process of claim 1, in which at least a portion of the second and/or fourth CO-enriched gas is sent to a process for producing biofuel by fermentation.

3. The process of claim 1, in which at least a portion of the second gas and/or fourth gas is separated by partial condensation and/or washing and/or distillation to produce the fourth gas enriched in CO and depleted in hydrogen and nitrogen relative to the second gas, and a fifth gas depleted in nitrogen and CO and enriched in hydrogen relative to the second gas.

4. The process of claim 3, in which at least a portion of the fourth gas and/or of the fifth gas is sent to a/the process for producing biofuel by fermentation.

5. The process of claim 1, in which at least a portion of the third fluid is sent to the process for producing biofuel by fermentation.

6. The process of claim 1, in which the CO₂-enriched gas produced by temperature swing adsorption is mixed with the CO₂-enriched gas.

7. The process of claim 1, in which the first CO-enriched gas is enriched in nitrogen relative to the waste gas.

8. The process of claim 1, in which the second CO-enriched gas contains at least 60% mol of CO.

9. The process of claim 8, in which at least a portion of the second gas is separated at cryogenic temperature by partial condensation and/or washing and/or distillation to reduce its nitrogen content, forming a gas containing at least 80 mol % of CO and also hydrogen and a nitrogen-enriched gas.

10. The process of claim 1, in which the waste gas contains argon and separation by partial condensation and/or washing and/or distillation produces an argon-enriched fluid.

11. The process of claim 1, in which cryogenic separation produces a fluid containing at least 80% hydrogen.

12. The process of claim 1, in which the CO₂-depleted and CO-enriched gas contains at least 85% of the CO present in the waste gas sent to the first adsorption unit.

13. The process of claim 10, in which a regeneration gas sent to the second adsorption unit is formed from a portion of the second gas containing at least 60% mol of CO.

14. The process of claim 10, in which a regeneration gas sent to the second adsorption unit is formed from a gas produced by cryogenic separation.

15. The process of claim 1, in which the CO₂-enriched gas is separated in a separation unit by partial condensation and/or distillation and/or solidification, forming at least one gas richer in CO and hydrogen than the CO₂-enriched gas, and this at least one gas richer in CO and hydrogen is sent to be separated in the first adsorption unit.

16. The process of claim 1, in which the CO₂-enriched gas contains water and is dried in a drying unit upstream of the separation unit by partial condensation and/or distillation and/or solidification, a regeneration gas containing CO and/or hydrogen is used to regenerate the drying unit and is then sent to be separated in the first adsorption unit.
